(19) United States
(12) Patent Application Publication
(10) Pub. No.: US 2016/0314531 A1
(43) Pub. Date: Oct. 27, 2016

(54) Targeted Benefit Account

(71) Applicants: Tracy L. Dangott, Chicago, IL (US); Richard Angerosa, Mineral Bluff, GA (US); Edward B. Koslow, Dunedin, FL (US); Rick McKinney, Chicago, IL (US); Chris Paton, Northbrook, IL (US); Brian Kibble-Smith, Oak Park, IL (US)

(72) Inventors: Tracy L. Dangott, Chicago, IL (US); Richard Angerosa, Mineral Bluff, GA (US); Edward B. Koslow, Dunedin, FL (US); Rick McKinney, Chicago, IL (US); Chris Paton, Northbrook, IL (US); Brian Kibble-Smith, Oak Park, IL (US)

(73) Assignee: JPMorgan Chase Bank, N.A., New York, NY (US)

(21) Appl. No.: 12/767,525

(22) Filed: Apr. 26, 2010

Related U.S. Application Data
(60) Provisional application No. 61/172,888, filed on Apr. 27, 2009.

(51) Int. Cl. G06Q 40/00

(52) U.S. Cl. CPC G06Q 40/06

(57) ABSTRACT

Exemplary embodiments provide a single financial account that may contain funds in either an actual or a notional balance from one or more payment, benefit, and/or entitlement programs with the funds being made available to an account holder through the use of a multipurpose financial account card that may be used for transactions. The account may accept funds from various non-governmental sources and prevent comingling of funds where comingling is not permitted or enable comingling of funds where permitted or encouraged. The access to and use of the funds may be governed by one or more hierarchical rules based on the type of funds' that determine the funds application to the transaction.

### CROSS REFERENCE TO RELATED APPLICATIONS

This application claims the benefit of U.S. Provisional Application No. 61/172,888, filed Apr. 27, 2009, the contents of which are hereby incorporated by reference in their entirety.

This application is related to U.S. Pat. No. 6,615,190, entitled “Sponsor Funded Stored Value Card,” the contents of which are hereby incorporated by reference in their entirety. This application is related to U.S. Pat. No. 7,512,566, entitled “System and Method for Using a Stored Value Account Having Subaccount Feature,” the contents of which are hereby incorporated by reference in their entirety. This application is also related to U.S. patent application Ser. Nos. 10/201,589 and 12/347,527, both entitled “Multiple Account Advanced Payment Card and Method of Routing Card Transactions,” the contents of which are hereby incorporated by reference in their entirety.

### FIELD OF THE INVENTION

The present invention relates generally to Electronic Benefits Transfer (EBT) accounts, as well as other government agency and/or corporate payment programs, and the use of a financial account card to access such accounts. More specifically, the invention provides a single financial account that may contain funds in either an actual or a notional balance from one or more payment, benefit, and/or entitlement programs with the funds being made available to an account holder through the use of a multipurpose financial account card that may be used for transactions. The account may accept funds from various non-governmental sources and prevent comingling of funds where comingling is not permitted or enable comingling of funds where permitted or encouraged. The access to and use of the funds may be governed by one or more hierarchical rules based on the type of funds' that determine the funds application to the transaction.

### BACKGROUND OF THE INVENTION

Many point-of-sale (POS) and other financial transactions take place using card transactions. In these transactions, to provide payment, a card user presents a financial account card, such as a credit card, a bank, debit or automated teller machine (ATM) card, or possibly a stored value card.

In a typical card payment transaction, for example a credit card transaction, a buyer presents a credit card to a merchant at the point of sale. The POS apparatus reads account information from the card and passes this information along with the transaction data to the merchant's card processing system for approval from the card processor or qualifier that maintains the buyer's account. The approval (or denial) is transmitted back from the card processor or qualifier to the merchant. This processing system is also used during settlement of the transaction to provide transfer of the funds from the issuing institution to the merchant's account. These types of transactions are called open loop network transactions. These transactions are typically of an unrestricted nature regarding both the items that may be purchased and the nature of merchant participation/selection. With credit cards also, a consumer has a line of credit that the transactions are credited against.

The consumer typically has one or more bank accounts wherein funds are deposited by the consumer for their own use. Such an account is referred to as a Demand Deposit Account (DDA).

Certain consumers receive funds or have access to funds from various benefit and entitlement programs. These programs are typically administered at a government level, by an agency, such as state or federal government agency. For example, the Social Security Administration administers the Social Security Program. The funds are issued and deposited into a designated account, typically an Electronic Deposit Account (EDA). Some accounts issue the consumer a card, such as a debit card, that allows transactions to be made against the funds received from the benefit or entitlement program and residing in the EDA. In cases where the consumer may be receiving multiple benefits and/or entitlements, the funds may be separated over multiple accounts. These consumers are often provided with a different card for each benefit or entitlement program and its respective account. Therefore, a consumer in this situation ends up with a plurality of cards and accounts to track and manage. Furthermore, the customer cannot access and spend funds from this plurality of accounts in a single transaction. In a typical situation today, a consumer has at least three different cards and as many account, such as an EBT card for the Supplemental Nutrition Program (SNAP), a debit card for payroll and/or personal funds, and another debit card for other entitlements, such as unemployment.

The processing of transactions for these benefit and entitlement programs are subject to various rules, typically implemented by the agency providing the funding. These rules may delineate exactly what the funds are to be used for, such as use at a particular class of merchants or to purchase a particular good or service. Transactions are denied for a particular set of funds if the amount exceeds what is available to the consumer, if access is attempted at a non-qualifying merchant, or if a non-qualifying item is purchased. Many of these benefit or entitlement programs are associated with a closed look network which allows EBT only at a POS terminal. These EBT transactions require the use of a PIN. For example, SNAP transactions are conducted over a closed look network.

A transaction example, using the Supplemental Nutrition Assistance Program (SNAP, formerly known as the “Food Stamp Program”), is provided to illustrate a typical use of an EBT card. For a SNAP recipient to complete a typical food purchase at a grocery store using an EBT card, the transaction must meet numerous criteria: (1) it must originate from a retail POS device rather than an Automated Teller Machine (ATM) since SNAP dollars cannot be accessed as cash; (2) the POS device must be operated by a store that is authorized by the USDA Food and Nutrition Service (FNS) to participate in SNAP; (3) the EBT card must be recognized by the system as valid; (4) the recipient must have entered the correct Personal Identification Number (PIN); and (5) there must be sufficient SNAP funds available in the EBT cardholder's account to cover the purchase. If any of these elements is not present, the transaction is denied.

### SUMMARY OF THE INVENTION

According to an exemplary embodiment, a computer implemented method is provided. Enrollment data for a program is received by a computer processor over a computer based network. The program has funds associated with it, wherein the use of the funds is governed by a set of predetermined rules. An account is established for a consumer who is enrolled in the program based upon the enrollment data. The account may have more than one program associated with it. Following establishment of the account, a transaction card is provided to the consumer. The transaction card allows the consumer to perform transactions against the account. The originator of the enrollment data is notified of the establishment of the account. The originator may subsequently transmit funds associated with the program over the computer based network for deposit into the account. If more than one program is associated with the account, the funds for the multiple programs may be deposited into the account. The consumer may perform a transaction with the transaction card and the transaction data may then be received over the computer based network and processed by the computer processor. The set of rules is applied to the transaction data to determine if the transaction qualifies for use of the funds. The set of rules may be hierarchical in nature and apply the funds in a manner from most restrictive to least restrictive. Further, the funds may be applied based on date of issue or deposit such that older funds are used prior to newer funds. The funds may be categorized based on usage restrictions. The rules may follow a vertical pattern within a category and then move horizontally to a lesser restrictive category when being applied. Funds within a category may further have a priority associated therewith that may override older dated funds. An authorization code for the transaction is then transmitted over the computer based network to the originator of the transaction data.

Advantages of this invention in addition to those described above are apparent from the following detailed description of the exemplary embodiment of the invention. The recitation of this summary of the invention is not intended to limit the claimed invention. Other aspects, embodiments, modifications to and features of the claimed invention will be apparent to persons of ordinary skill in view of the disclosures herein. Furthermore, this recitation of the summary of the invention, and the other disclosures provided herein, are not intended to diminish the scope of the claims in this application.

### BRIEF DESCRIPTION OF THE DRAWINGS

The present invention is described in detail with reference to the examples of embodiments shown in the following figures in which like parts are designated by like reference numerals.

FIG. 1 is a basic flowchart of a method of establishing a targeted benefit account according to an exemplary embodiment of the invention.

FIG. 2 is a basic flowchart of a method of using a targeted benefit account according to an exemplary embodiment of the invention

FIG. 3 is a basic flowchart of a rule hierarchy for a targeted benefit account according to an exemplary embodiment of the invention.

FIG. 4 is a basic flowchart for a funding a degree of control hierarchy for a targeted benefit account according to an exemplary embodiment of the invention.

FIG. 5 is a system diagram of a transaction processing system according to an exemplary embodiment of the invention.

FIG. 6 is a system diagram of a transaction processing system for an EBT transaction according to an exemplary embodiment of the invention.

FIG. 7 is a chart of an account balance according to an exemplary embodiment of the invention.

FIG. 8 is a chart of an account balance according to an exemplary embodiment of the invention.

FIG. 9 is a chart of an account balance according to an exemplary embodiment of the invention.

FIG. 10 is a chart of an account balance according to an exemplary embodiment of the invention.

FIG. 11 is a chart of an account balance according to an exemplary embodiment of the invention.

FIG. 12 is a chart of an account balance according to an exemplary embodiment of the invention.

FIG. 13 is a chart of an account balance according to an exemplary embodiment of the invention.

FIG. 14 is a chart of an account balance according to an exemplary embodiment of the invention.

FIG. 15 is a chart of an account balance according to an exemplary embodiment of the invention.

### DETAILED DESCRIPTION OF THE PREFERRED EMBODIMENTS

The present disclosure provides numerous inventive features relating to embodiments of an account that enables consumers to electronically access funds made available to them under various benefit and entitlement programs. Access is provided in a similar manner to how a consumer would access their own private funds located in their own bank account. Multiple paths to access the funds are provided including, but not limited to, a debit card, the telephone, and a computer based network, such as the internet or a local area network. Exemplary embodiments may provide a unitary experience in both the handling and processing of said benefit and entitlement programs. This unitary experience is targeted for both the consumer and the agencies which ultimately administer the benefit or entitlement program, as well as the merchants wherein the funds associated with such programs are used by creating a new set of consumers possessing a transaction card and streamlining the payment or reimbursement process. A financial institution may maintain and administer the account, including providing all reporting requirements to the agencies responsible for the benefit or entitlement. The account does not provide a check-writing capability but cashable checks to specific payees may be ordered, such as over the telephone or the internet, for remote generation and mailing. The account can accept and track deposits outside of the various benefit and entitlement programs such as, but not limited to, wages, tax credits and refunds, and charitable donations.

Various features and alternative embodiments of the invention are described with reference to their exemplary use in certain embodiments, but it will be readily appreciated that the features could alternatively be incorporated into other embodiments of accounts and financial account cards. The invention includes these and other variations, as will be appreciated by persons of ordinary skill in the art in view of the present disclosure. Furthermore, the various features described herein may be used separately from one another or in any suitable combination. The present disclosure illustrating various exemplary embodiments is not intended to limit the invention in any way.

Accordingly, exemplary embodiments of the present disclosure provide a targeted benefit account for a consumer which allows access to funds. The funds may be from varying sources and/or programs with varying points of access to the funds. The targeted benefit account may be maintained and administered by an entity, such as a transaction processing company or a financial institution. For example, the financial institution may be a bank or a credit union. Exemplary embodiments may provide access to the funds through use of a financial account card. The financial account card may be a multi-purpose type card and be configured so that one swipe of the card is required to complete a transaction, even if the transaction involves goods and/or services which are qualified under more than one benefit or entitlement or consumer owned funds. The processing of the transaction, and hence, the access to the various funds in the account, may be governed by a set of rules. In exemplary embodiments, these rules are applied by the financial institution that processes the transaction and maintains the account. Exemplary embodiments further provide the consumer with a single card for use with a plurality of programs at a plurality of locations, providing multiple points of access to the funds. Further, the account and access thereto may be portable such that the consumer may designate the card account as the repository for a variety of deposits from a variety of public sector and private sector funding agencies. Accordingly, the present invention may be computer implemented using one or more computers which may communicate over a computer based network. The computer implementation may include a combination of software and hardware.

There are presently a number of benefit and entitlement programs available to consumers. Some programs may be run by private agencies or companies. Many programs are based upon need and certain requirements must be met by the consumer to qualify for the benefit or entitlement. Typically, the consumer must apply for the benefit or entitlement with the responsible agency and be approved by the agency to receive the benefit. For example, unemployment insurance must be applied for and be approved to receive the benefit after certain conditions are met. Some benefits and entitlements are based on a voluntary election and/or contribution by the consumer. For example, health savings accounts are typically based on voluntary consumer contributions. Each program may be administered at various levels of government by an appropriate agency; a program may be administered by more than one agency. These programs may include, but are not limited to:

| | |
|---|---|
| Supplemental Nutrition | Refugee assistance |
| Assistance Program (SNAP, | |
| commonly called Food Stamps) | |
| Temporary Assistance to Needy | Assistance to the blind |
| Families (TANF) | |
| Womens, Infants, Children (WIC) | Child support |
| Social Security | Child care subsidies |
| Supplemental Security Income | Foster care subsidies |
| (SSI) | |
| Workers compensation | Elder care subsidies |
| Unemployment insurance | Youth employment |
| Trade Adjustment Act | Low-Income Heating Assistance |
| Veterans benefits | Transit subsidies |
| Disaster Assistance | Inmate release stipends |
| Individual Development Accounts | Other payments (jury duty, etc.) |
| Health Savings Account (HSA) | Training Benefit(s) |

Each of the benefit or entitlement programs may have a particular set of rules governing the use and/or the locations for use of the funding provided for that particular program. The rules are typically restrictive in nature, sometimes defining specific products, commodities, or services that may be purchased with the funds provided. The restrictive usage may vary from restricted to partially restricted. In restricted usage programs, the funds typically may only be accessed via registered retailers providing specific services and/or goods. No ATM access is typically allowed and no cash back at POS terminals is possible. For partially restricted funds, the funds may be accessed at registered retailers based on a certain merchant category code (MCC) which defines goods and/or services for a particular benefit type. For example, the WIC program only allows the purchase of certain items in certain quantities. Accordingly, the WIC program does not involve specific funding amounts, but is strictly related to the goods purchased. Further, goods under the WIC program can only be purchased from authorized WIC retailers. Another example is the SNAP program, commonly known as food stamps. SNAP benefits can only be used at certified retailers or providers for qualifying food items. Some programs may have less restrictive rules that allow the funds to be used for a wide range of transactions. Certain programs may have unlimited or unrestricted usage of the funds for any transaction. These funds may be accessed at either a POS or an ATM. Getting cash back at a POS is typically allowed. For example, unemployment insurance funds have unlimited use for whatever the consumer may desire. It should be appreciated that a consumer's own, private funds can be used in an unlimited manner. In exemplary embodiments, rules may be handled based upon a transaction type and/or an originator of the transaction. A single account may contain multiple fund types from a plurality of programs where each of the fund types has its own set of rules.

The targeted benefit account may be programmed with specific rules corresponding to each benefit and/or entitlement the consumer has access to. This allows the targeted benefit account to handle each incoming transaction and apply appropriate funds to the transaction based on the rule set. In exemplary embodiments, the rules for fund usage pertaining to a particular benefit or entitlement are determined by the provider of the funds or benefit, such as the government agency which administers the benefit, and are implemented for the targeted benefit account by the administrator of the account. The consumer may have no input regarding the usage of the funds for a particular benefit or entitlement, as well as the overall application of funds in the targeted benefit account towards a particular transaction. In alternative embodiments, the consumer may have input regarding funds and their usage for a particular transaction. The consumer's input may be limited to certain funds, such as funds that are less restricted in their usage. For example, the consumer may decide that they want their unemployment insurance used before their veteran's benefits are used for a given transaction, since these funds typically are unlimited in their usage. The consumer may be able to select the rules desired through an interactive interface such as a website or through a phone call with a customer service representative. Even in the use of unrestricted funds, legal requirements such as federal banking regulations may apply, determining some account functions. In some embodiments, a negative logic function may be applied where transactions flow over the Internet and Uniform Product Codes (UPCs) could be used to authorize or prohibit the purchase of specific items at the product level.

The rule set used by the targeted benefit account may be applied in a manner such that the most restrictive fund rules are applied first, before lesser restrictive fund rules. The targeted benefit account may further apply sub-rules within a given rule for a particular benefit. The targeted benefit account may be configured to use older funds prior to newer funds. This may be performed in order to prevent any funds or benefits from expiring. For example, disaster relief funds may have an accelerated expiration date, meaning the funds must be used within a certain time frame. The rule set would be configured to ensure that those funds are used first for qualifying transactions. Exemplary embodiments may be configured to use funds from benefit or entitlement programs prior to using the consumer's own funds. If the rule set is gone through in its entirety and no qualifying funds are found or there are insufficient funds, then the transaction may not be approved. In alternate embodiments, a partial approval may be granted if qualifying funds are found that may be used to fund a part of the transaction. The consumer may then be given the option of completing the partial transaction or canceling the entire transaction. The consumer may choose to complete the transaction using cash to satisfy the difference between the total amount and the partial approval amount.

The targeted benefit account may have a rule set for settlement and correction of errors. In exemplary embodiments, a rule set may be implemented for refunds and returns of goods or services purchased through a transaction wherein funds from a benefit or entitlement were applied. The returned funds would be returned to where they came from. For example, if the consumer purchased $125 of tools with a training benefit ($100) and unemployment insurance ($25) and then returned $50 of tools, $25 may be credited back to the unemployment insurance and $25 back to the training benefit. The least restrictive funding source, the unemployment insurance, was credited first on the return, then the remainder, after that source was made whole, is credited back to the training benefit from where it originated. It should be appreciated that there may be situations where the consumer may attempt to defraud or “game” the system, such as making a purchase with training funds and then returning the purchase in an attempt to receive unrestricted cash back. In alternative embodiments, rules may be implemented wherein such a return would be handled through the crediting of the consumer's training balance in a similar manner to that described above. Such a rule may be structured to return funds directly to the sub-account that the funds originated from in the transaction.

Additionally, the targeted benefit account may have rules to determine rebates or refunds associated with certain benefit or entitlement programs. These rebate rules may provide funds into the targeted benefit based on qualifying purchases or other criteria as established by the program administrator. For example, the federal government's “Healthy Foods Initiative,” may provide a discount or rebate based upon the purchase of certain food products, such as fresh produce. In this example, the discount or rebate is provided against the consumer's SNAP allotment. Government cash or other incentives may also be provided. For example, the government cash or incentives may be provided for completion of a fitness program or a nutrition class.

The targeted benefit account of the present invention may be used with each benefit and entitlement program, in any combination. In alternative embodiments, additional funding sources may be used also, such as checking and savings accounts. The targeted benefit account therefore provides a single account to which the funds for each of these programs may be deposited by each agency or entity controlling each particular program. Typically, said deposits are conducted electronically through electronic funding transfer, such as through an Automated Clearinghouse (ACH) transaction. Other deposit methods for the targeted benefit account are possible, such as by a check or cash. The targeted benefit account may be thought of as a purse with multiple pockets therein, wherein each program or account type has its own pocket wherein the funds for that program are contained. The targeted benefit account may be designed to keep funds from different sources separate; that is, to prevent comingling of certain funds as required. Accordingly, the administrator of the account tracks each program with funds in the account and the amount that program is allocated. Applied rule sets determine when money is pulled from a particular “pocket” for a given transaction. In some embodiments, programs with similar rule sets may have their funding mixed together or commingled and accessed as one lump sum. For example, payroll and unemployment insurance funds may be commingled in the targeted benefit account since both may have unrestricted usage for the funds.

Exemplary embodiments of the present invention may be used with United States currency. Alternative embodiments may be used with other currencies and even a mixture of currencies. In these embodiments, conversion rules may be applied to the transactions to normalize the currency prior to application of the rule set. A conversion rate may have to be determined and adjusted periodically to account for fluctuations in the marketplace.

Furthermore, benefits and entitlement programs may handle funding distribution in differing manners. For example, some programs, such as unemployment insurance, are prepaid or fully funded such that the balance reflected in the targeted benefit account will be an actual balance that reflects actual funds. Other programs, such as SNAP, may be post-funded on spend such that the balance reflected in the targeted benefit account is a notional balance reflecting an available amount. The financial institution must then draw funds at a specified interval from an outside source, such as the Federal Reserve, to cover transactions posted against the SNAP benefit. For example, the financial institution may reconcile the account and request appropriate SNAP funds from the Federal Reserve to balance each targeted benefit account on a daily basis. Other accounts may be post-funded on load. For example, a customer may have a payroll card issued to them with $100 on the card that the financial institution has funded on instructions of the payroll provider. The customer has access to the funds on the payroll card and the payroll provider is liable for the $100, regardless of whether the customer spends it. The payroll provider will be liable to reimburse the financial institution for the amount provided. Some accounts may have a feature for matching funds. For example, funds placed in an account by an individual may be matched by the account sponsor. Escheatment may also be provided for under various conditions. Rules for escheatment of funds in the targeted benefit account may be promulgated by state or federal agencies. Private organization sponsors of such accounts may also have rules.

The targeted benefit account may be used for non-financial purposes, such as tracking time and attendance in training programs or authorizing individuals for Medicaid services at the point of service or treatment. In each case, any and all program rules, requirements and reporting, will be handled via the administrator, such as the financial institution, of the targeted benefit account.

In exemplary embodiments, there is no credit associated with the targeted benefit account. Accordingly, the targeted benefit account can be provided to the consumer without certain requirements that may apply to an account set up by the consumer themselves. Such requirements may include, but are not limited to, monthly fees, credit checks, or minimum balances. Given that the targeted benefit account may be offered independent of financial wherewithal, it can be available to support consumers through various phases of their lifetime, such as through education, employment, unemployment, public assistance, or retirement. Therefore, the targeted benefit account offers a level of flexibility not seen in typical benefits accounts or DDA's. The consumer who enrolls in the targeted benefit account may have the ability to accept and access funds and benefits through a broad variety of sources. Once enrolled in the targeted benefit account, the consumer who has the need to seek benefits or entitlements under programs such as SNAP, TANF, Social Security, SSI, unemployment, and others, as listed above, has a destination for electronic deposit of the program funds or other benefits. The programs selected by or used by the consumer for the targeted benefit account need not originate at the same level of government or even from one jurisdiction. As described above, the targeted benefit account may be portable for use with a succession of sources. For example, migrant workers may have access to a payroll card for a job with one grower in one geographic area or jurisdiction but may travel to another geographic area or jurisdiction and work for another grower. The same targeted benefit account and card may be used for this successor employment or for any unemployment compensation they may receive as they travel for work and experience periods of unemployment. It should be appreciated however, that some benefits may not be portable because of rules imposed by the sponsoring agency and such benefits may be used within a certain geographic area. For example, a training benefit may be tied to particular training providers within a city or state. Only those listed providers may be used and therefore the benefit may not be portable.

In accordance with exemplary embodiments, a variety of funding sources may be used to provide fund inflow into the targeted benefit account. Listed below are non-governmental or non-benefit program sources that may be used to provide funds for the targeted benefit account. This list is not meant to be inclusive of every possible source, but is provided as an illustration of sources for an embodiment of the present invention. It should be appreciated that other sources of funds are possible.

Wage-related payments such as payrolls and expense reimbursements

Tax refunds or credits such as the Earned Income Tax Credit (EITC)

Retirement vehicles such as 401k and 457 plans

Tuition assistance and reimbursement

Health care insurance subsidies

E-commerce (e.g., PayPal)

Alimony and child support

Pensions and annuities

Insurance proceeds

Loan proceeds

Charities

In exemplary embodiments, as described above, the consumer is issued a multipurpose account card for use with the targeted benefit account. This account card enables the consumer to conduct transactions at merchants for the purchase of goods and/or services. The account card of the present invention may appear similar to a conventional credit card or debit card. For example, the account card may have the form, fit and function of a conventional credit, bank or stored value card. In some embodiments, the card may have an appropriate transaction network logo and/or hologram contained thereon. The card may therefore be associated with a branded debit network For example, the Visa®, MasterCard®, or Quest® networks. Quest is not a physical network, but is a set of protocols applicable to EBT transactions for SNAP, TANF, and other programs that rely on currently deployed ATMs and POS devices and their access to the Electronic Funds Transfer (EFT) network where online, PIN-secured debit transactions are carried out. It should be appreciated that the branded debit networks listed herein are provided as exemplary only and the term branded debit network may include any similar network that supports both PIN and signature based transactions. This network logo and/or hologram may designate the network that the card may be used with. The account card is manufactured to comply with all applicable federal laws and regulations, as well as all applicable industry standards for transaction cards. In some embodiments, the account card may have multiple transaction networks associated therewith and appropriate logos and/or holograms thereon for the associated transaction networks. For example, the account card may be associated with the MasterCard and Quest networks and display both logos to show that the card is associated with both networks.

The account card may have machine readable data included on the card that pertains to the account information associated with the consumer. Typically, the machine readable data is encoded upon a magnetic stripe located on the back of the card. Account data for more that one account may be encoded upon the card, making the card a multipurpose card. In alternative embodiments, the card may include a smart chip or a radio frequency chip, such as for Radio Frequency Identification (RFID) or Near Field Communications (NFC). The card may include combinations of the magnetic stripe and one or more chips, such as a smart chip and an RFID chip. The card may have an appropriate logo, such as Blink, on it to indicate RFID capability.

The consumer may use the account card as any typical transaction card to complete transactions. In some embodiments, the consumer may be required to enter a PIN to complete the transaction, such as is typically done with a debit or ATM card. It should be appreciated that EFT debit requires the use of a PIN to complete the transaction, whereas other networks, such as Visa and MasterCard may accept either a PIN and/or a signature. The consumer may be required to select an appropriate transaction type at a POS terminal to complete the transaction. In accordance with exemplary embodiments, the consumer may select the most restrictive transaction type. For example, the consumer may be required to select an “EBT” button or its equivalent on the POS terminal. By selection of the “EBT” button, the transaction would be processed through a full set of the rules, starting with application of rules for the most restrictive account funds and proceeding to the least restrictive account funds.

It should be appreciated that more than one card may be associated with a TBA. Various implementations of embodiments may issue more than one card to the consumer. For example, a suite of cards may be issued. Each card may be associated with various benefits and/or entitlements. Benefits and entitlements may be grouped into various categories and the funding associated with those funding sources may be associated with a card. For example, a consumer may have two cards issued. One card may be for programs with restrictive funding rules, such as SNAP or EBT WIC, and the other card may be for programs with less restrictive funding rules, such as alimony or veterans benefits.

In some embodiments, the processing of the transaction may be impacted by the button selection. For example, the consumer may select the credit or debit button instead of the “EBT” or equivalent button. In this case, a portion of the processing and account rules may be effectively skipped since the transaction will be coded as a credit/debit transaction. Accordingly, rule sets that apply to certain benefits and/or entitlements, such as those that are closed loop network transactions, may be effectively skipped, and processing of the transaction may proceed to using rules that apply to open loop network transactions. The rule set processing will run through the rules starting at the top of the rule hierarchy for each transaction, however certain rules may not apply to certain transactions and therefore would not be applied to the transaction and would be effectively skipped in the hierarchy. The selection of the credit button may therefore effectively skip a portion of the rule set that applies to closed loop transactions, such as SNAP, and proceed to applying rule sets that pertain to funds with unrestrictive usage, such as unemployment insurance or payroll. Alternatively, a specific button may be provided that is specific for the account card of the present invention, such as a “Targeted Benefit Account” or “TBA” button. In some embodiments, no button selection by the consumer may be required. In such embodiments, a merchant may select an appropriate transaction type or no action is required on either the consumer's part of the merchant.

In some embodiments, the button selection may not alter the rule application. The rule set would be applied to every transaction and all funds considered for use, regardless of the transaction coding based upon the button selection. For example, in contrast to the preceding credit/debit button example, selecting the credit/debit button would not alter the processing of the transaction from the processing that may be applied for selection of the “EBT” button or the “TBA” button. Further, the consumer may use the account card to withdraw cash at various locations, such as ATMs and/or POS locations at various merchants. The cash withdrawal may be subject to a set of rules.

The transaction data may contain information pertaining to the transaction and the transaction may be categorized by the merchant based on the type of products purchased. For example, the UPC may be used to distinguish the goods purchased. Some merchants may use manual separation of goods into different categories for different benefit programs such that multiple transactions may be required or the merchants may manually tag qualifying items for a particular program within a given transaction. The targeted benefit account will use the categorization of the transaction in applying the rules to determine which funds may be used to cover the transaction. In other transactions, a merchant category code (MCC) may be applied to the transaction by the credit/debit card system. The MCC is a four digit number assigned to a merchant to classify the merchant by the types of goods or services they provide. Accordingly, the MCC may be used by the targeted benefit account to apply the rules. For example, certain benefits, such as training benefits and transit subsidies, may be tied to particular MCCs. Therefore, only qualifying MCCs will enable the use of funding from these benefit sub-accounts in the targeted benefit account. Another use of MCCs may be with cards associated with or issued for disaster assistance or relief benefits to be used in the processing of transactions with a TBA card to ensure the transaction qualifies for the benefit usage.

In alternative embodiments, the merchant may separate the transaction into multiple transactions during their own processing. The consumer may see the transaction as a single transaction, however the financial institution may receive multiple transaction data from the merchant. The rules may be applied by the financial institution to each transaction accordingly.

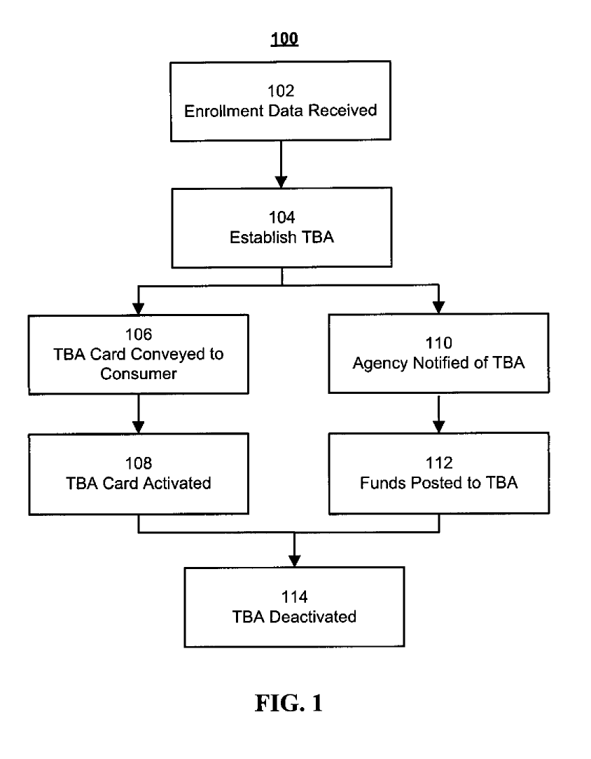

The use and operation of exemplary embodiments of the present invention will now be described referring to FIGS. 1 through 3.

FIG. 1 depicts a flow chart of a method of establishing a targeted benefit account according to an exemplary embodiment. Exemplary method 100 is provided by way of example, as there are a variety of ways to carry out the methods disclosed herein. The method 100 as shown in FIG. 1 may be executed or otherwise performed by one or a combination of various systems, such as a computer implemented system. Each block shown in FIG. 1 represents one or more processes, methods, and/or subroutines carried out in the exemplary method 100. Each block may have an associated processing machine or computer, or the blocks depicted may be carried out through one processor machine. Input may be desired from a consumer or user during various parts of the below described method, the input may be accomplished through a user interface. Referring to FIG. 1, the exemplary method 100 may begin at block 102. At block 102, enrollment data is received for a benefit or entitlement program from an agency. At block 104, a targeted benefits account or TBA is established. At block 106, a TBA card is conveyed to the consumer. At block 108, the TBA card may be activated by the consumer. At block 110, the agency is notified that the TBA has been established and is provided the TBA information. At block 112, the agency may post funds to the TBA. At block 114, the TBA is deactivated. These steps will be described in greater detail below.

While FIG. 1 illustrates certain steps performed in a particular order, it should be understood that the embodiments of the present invention may be practiced by adding one or more steps to the processes, omitting steps within the processes and/or altering the order in which one or more steps are performed.

At block 102, enrollment data is received. The enrollment data may be received from an agency or other entity. The enrollment data may be received and processed electronically by a computer system. The enrollment data may contain data which pertains to a particular benefit or entitlement sponsored by and/or administered by the agency entity. The benefit or entitlement may be one of many possible programs, such as those listed above. For example, enrollment may be received from a state employment commission containing the names of consumers eligible for unemployment benefits. The enrollment data may be for multiple benefits and entitlements programs. Further, multiple agencies or entities may submit enrollment data for a range of programs. The enrollment data may be sent by the agency in various formats, such as a batch file. The enrollment data may be received and processed by a computer system at a receiving entity. For example, the receiving entity may be a financial institution that administers and maintains the TBA. In some embodiments, the receiving entity may be a third party associated with the financial institution that processes the enrollment data. In the following description of the exemplary embodiments, the receiving entity will be referred to as a financial institution. However, this in no way is meant to limit the embodiments of the present invention as herein described.

At block 104, the TBA is established. An account number may be created that associates the TBA with a particular consumer as indicated in the enrollment data received at block 102. Prior to creation of the TBA, the financial institution may validate the consumer's name to see if a TBA has already been established. This validation may be performed to preclude a particular consumer from having multiple accounts. If an account already exists, then the benefit from the enrollment data would be added to the existing TBA. The financial institution may then establish a set of rules to apply to the TBA. The rules may be based on the benefits and/or entitlements provided by the agency, may be imposed by law and regulation, or may be an update to existing rules for an existing account. The rules may be based upon guidance provided by the agency on how the funds are to be used. It should be appreciated that each TBA account or group of accounts in a particular area or location or associated with a particular financial institution may be customized to a certain degree based on particular needs. Therefore, a set of TBA accounts in one area may differ from a set of TBA accounts in a different area. In exemplary embodiments, a master set of rules may be maintained that encompasses all the benefits and entitlement programs associated with each TBA maintained by the financial institution. Accordingly, this master rule set would be applied to each transaction for each account. These master rules may be updated as new benefits and/or entitlements are associated with particular TBAs or are deleted therefrom. In other embodiments, a tailored set of rules may be developed and applied to each TBA. The tailored rules would be specific to the specific TBA and the benefits and/or entitlements associated therewith.

At block 106, a targeted benefit account card, or TBA card, is conveyed to the consumer. The TBA card may be configured as described above. The TBA card may be sent via a secure means to the consumer. For example, the TBA card may be sent via first class mail to the consumer. In other embodiments, the TBA card may be issued directly to the consumer. As described above, more than one TBA card may be issued to the consumer. For example, the consumer may be issued two TBA cards with each card having a particular set of programs, or benefits and/or entitlements, associated therewith.

At block 108, the TBA card may be activated by the consumer. The activation of the card may be completed using a variety of methods. For example, the card may be activated over the phone or by using a computer to access a designated website on the internet. The consumer may be told to call a toll-free phone number and then be asked a series of questions to activate the card. The questions may be asked for security purposes. A live operator may answer the call and interact with the consumer. Alternatively, a computer based system may be used with pre-recorded messages and use a voice activated response system. Alternatively, the consumer may go to a designated website on the internet and enter requested data to activate the card. A computer system may receive and process the data entered by the consumer. The computer system may activate the card. Upon successfully activation, the consumer may receive a notification through the website that the card has been activated. In some embodiments, no activation of the TBA card may be required. If a PIN is required for the TBA card, then the PIN may be mailed separately to the consumer.

At block 110, following establishment of the TBA at block 104, the responsible agency or entity is notified of the TBA's establishment. Account number and other pertinent TBA data may be sent to the agency or entity. The notification may be completed electronically. For example, an electronic notification may be sent over a computer based network. The data passed to the agency or entity from the financial institution may be sent in the same batch file that contained the original enrollment data from block 102, such as be appending the batch file with the new data. The agency may review the account listing and validate the listing against their records to confirm eligibility for the consumer's listed. The agency may provide appropriate feedback to the financial institution if corrections are required.

Continuing at block 112, funds may be posted to the TBA by the agency or entity. The agency may electronically send funds for deposit into the TBA. These funds may be sent even if the consumer has not received or activated the TBA card. The funds may be available for use in the TBA based upon an availability date given by the agency. For example, the funds may be deposited on the 10^{th} of the month and may not be available for use until the 15^{th} of the month.

At block 114, the TBA may be deactivated. The deactivation may be completed for a variety of reasons. For example, the consumer may no longer be eligible for the TBA and the associated programs. In some cases, a portion of the TBA may be deactivated. For example, a consumer may no longer be eligible for a specific program, such as SNAP. The TBA would no longer receive funds for the SNAP program and the TBA card would no longer be able to be used for the SNAP program; that is, selections at a POS terminal, as described herein, relating to the SNAP program would result in a declined transaction or the transaction would be processed against other applicable funds in the TBA. In other cases, the TBA or a portion of the TBA may be deactivated because of expiration of the funds. Some funding may have an expiration date and if the funds are not used by this date, then they may no longer be accessible to the consumer. The funds may escheat to the state or responsible agency based on state law. Once the TBA is deactivated, the TBA card may no longer function for use in transactions as described herein.

The TBA card may be lost by the consumer and the account may need to be deactivated to prevent fraudulent use of the card. In some case, only the TBA card may require deactivation with the TBA remaining active. In such a case, a new TBA card may be issued to the consumer. The TBA may be deactivated based on administrative action or to correct an error. In such cases, the TBA may be reactivated or reestablished following correction of the error or administrative action.

In alternative embodiments, as described above, the consumer may establish the TBA directly with the financial institution. The consumer would then be responsible for providing necessary TBA information to the funding agency to direct the disposition of the funds.

If the TBA is established by the consumer, then blocks 104, 106, 108, 110, and 112 may still be carried out. A difference may be in that the notification of the agency in block 110 may be performed using a new file, since no enrollment file was forwarded at block 102. In this case, the agency would verify and validate the consumer's eligibility for the particular benefit or entitlement and inform the financial institution accordingly. Alternatively, as described above, the consumer may provide the TBA information directly to the agency with an application for the program and the agency would then direct the funds to the TBA accordingly.

Additionally, the consumer may be able to deposit funds into the TBA directly, such as by depositing a check or cash. The deposit may be made at an ATM or at a branch of the financial institution. In some embodiments, the mail or internet may be used to facilitate the deposit. The TBA account card issued to the consumer may be used to access the account through an ATM to facilitate a deposit, or in some embodiment, a withdrawal of cash from the account. Further, other funding sources may be deposited directly into the TBA. For example, tax credits and refunds and charitable donations may be deposited directly into the account from their funding sources.

Upon activation of the TBA at block 104, the consumer may be given the opportunity to define personalized rules for the TBA for their own funds or funds that have no restriction upon them. In exemplary embodiments, this option may not be available for the consumer since the rules determining the fund disposition may be fixed and not alterable by the consumer or even the financial institution. Various paths to access the funds may be available, apart from the TBA card as described above. For example, telephone access to the TBA may be available. The telephone access may be automated or have a live operator or a combination of both. The TBA may be accessed using the internet through a web site or other interface. The financial institution associated with the TBA may provide computer terminals at their branches which are connected to a computer based network and provide TBA access. Additionally, customer service via live customer service representatives may be available to provide assistance and information to consumers regarding the TBA. A website may be available on the internet for assistance and information. Security features may be provided on the TBA to prevent unauthorized access. For example, the consumer may set up login information such as a username and password, as well as security questions, that need to be provided when accessing the TBA. It should be appreciated that other security measures may be used.

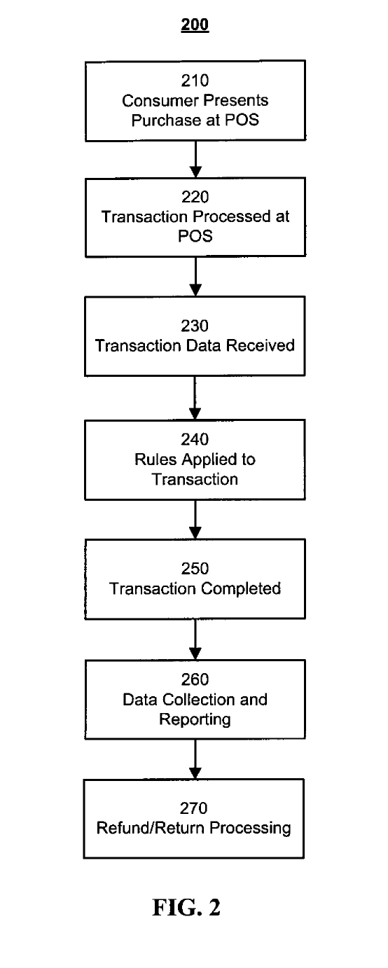

Turning to FIG. 2, a flow chart of a method of using a TBA according to an exemplary embodiment is depicted. Exemplary method 200 is provided by way of example, as there are a variety of ways to carry out the methods disclosed herein. The method 200 as shown in FIG. 2 may be executed or otherwise performed by one or a combination of various systems, such as a computer implemented system. Each block shown in FIG. 2 represents one or more processes, methods, and/or subroutines carried out in the exemplary method 200. Each block may have an associated processing machine or computer, or the blocks depicted may be carried out through one processor machine. Input may be desired from a consumer or user during various parts of the below described method, the input may be accomplished through a user interface. In accordance with exemplary embodiments, the method of FIG. 2 is expected to be performed after the method depicted in FIG. 1 such that the entering state for FIG. 2 is that the TBA is established, funds have been deposited into the TBA, and the consumer has the TBA card. Referring to FIG. 2, the exemplary method 200 may begin at block 210. At block 210, the consumer presents a purchase at a retail POS. At block 220, the transaction is processed at the POS. At block 230, the transaction data is received by the financial institution. At block 240, a set of rules in applied to the transaction. At block 250, the transaction is completed. At block 260, data is collected for reporting purposes. At block 270, refund/return processing is conducted, if required. These steps will be described in greater detail below.

While the method of FIG. 2 illustrates certain steps performed in a particular order, it should be understood that the embodiments of the present invention may be practiced by adding one or more steps to the processes, omitting steps within the processes and/or altering the order in which one or more steps are performed.

At block 210, the consumer presents a purchase at a POS. The POS can be located at a merchant, typically at a check-out counter or its equivalent. The purchase can be for goods and/or services. For example, the consumer may be at a grocery store. The consumer may desire to purchase a gallon of milk, flour, cigarettes, and a magazine.

At block 220, the transaction is processed. The processing of the transaction may include a cashier scanning the items using the UPC code or manually ringing them up in a cash register or equivalent computer system. Following this, the consumer may be presented with a total cost for the transaction. The consumer may then present their TBA card for payment. The TBA card may be swiped in a POS terminal or presented to the cashier for swiping or entry of the account number. The consumer may be requested to select a transaction type, either by the cashier or at the POS terminal. As described above, the consumer may select the most restrictive type of transaction. For example, the consumer may select EBT. The consumer may be presented with other selection options. The option selection may affect the rule set applied to the transaction. For example, the consumer may select the credit or debit button instead of the EBT button. A portion of the processing rules may be skipped since the transaction will be coded as a credit/debit transaction instead of an EBT transaction. Accordingly, rule sets that apply to certain benefits and/or entitlements, such as those that are closed loop network transactions, may be skipped entirely, and processing of the transaction may proceed directly to using rules that apply to open loop network transactions. Here, the selection of the credit button may therefore bypass a portion of the rule set that applies to any SNAP funds the consumer may have. The rules may then proceed to applying rule sets that pertain to funds with unrestrictive usage, such as unemployment insurance or payroll, if the consumer has those types of funds. Alternatively, the option selection may have no impact on the rule set or processing of the transaction such that selection of the button, such as EBT or credit/debit does not alter the application of rule sets to the transaction. Application of the rule sets to the transaction is described in block 240 below. In some embodiments, the consumer may be required to enter a PIN to complete the transaction.

At block 230, the transaction data is received by the financial institution. Following block 220, the transaction data may be transmitted over a branded debit network, such as the Visa or MasterCard or EFT network. The transaction data is then routed by the transmission network to the financial institution. The routing may be performed based on the account data from the TBA card and the selected transaction type. The transaction data may be an authorization request for the transaction. Data identifying the transaction may be received. For example, the financial institution may receive the device type, such as ATM or POS terminal, the transaction type, such as food stamps or cash/cash back, the terminal ID, which may serve as the provider ID, and the Merchant Category Code (MCC).

Continuing at block 240, rules are applied to the transaction. The rules are applied by the financial institution following receipt of the transaction data at block 230. The rules are the set of rules associated with the TBA, as described above. The rules may be applied by a computer, either software and/or hardware. The rules may be a set of hierarchical rules based on the benefits and/or entitlements associated with the TBA. The rules start with the most stringent restriction level and work to the most permissive level for usage of the funds available in the TBA. The rules may be structured to apply funds from benefits and/or entitlements before applying the consumer's own funds. The rules may be further structured with sub-rules, such that sub-hierarchal rules may exist within a particular hierarchy. In exemplary embodiments, the rules may follow a first in, first out methodology regarding the funds to ensure that the oldest funds are used first, since some benefits and entitlements may have expiration dates associated with the funds. As described above at block 220, the application of the rule set may be affected by the transaction type selected as reflected which button the consumer may push at the POS terminal. The rules may use the transaction data received at block 230. For example, the terminal ID may be used to determine if restricted usage benefits may be applied. The MCC may be used to determine if partially restricted usage benefits may be applied.

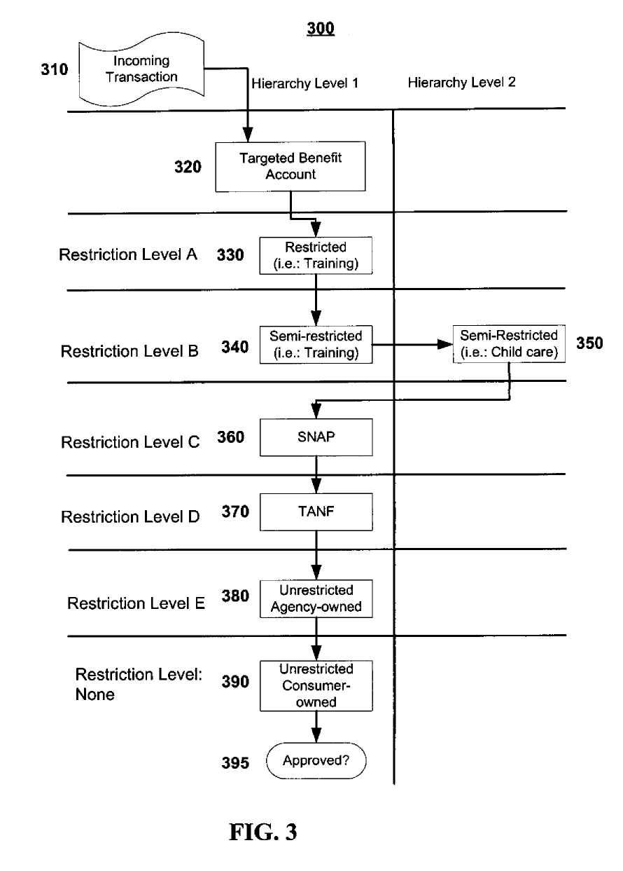

An example will now be provided to illustrate the functioning and application of the rules to a purchase. FIG. 3, described below, depicts an exemplary embodiment of a rule hierarchy.

Referring back to the purchase example from block 210, the consumer desires to purchase a number of goods at a grocery store, which is accepts SNAP benefits. The cashier has rung up the items and the total is $18.00, with the following items costs: $2 for the milk, $1 for the flour, $10 for the cigarettes, and $5 for the magazine. The consumer has presented their TBA card and the transaction data has been sent to and received by the financial institution. For the purposes of the example, assume the consumer has a SNAP benefit, including a SNAP disaster benefit, transit subsidies, a training benefit, child support, and unemployment insurance; each of these benefits has available funds in the consumer's TBA. Based on these benefits, a set of rules has been developed for the TBA and these rules will now be applied to the example transaction. It should be appreciated that any combination of benefits and/or entitlements may be used with the TBA and the selection of the above programs is for illustrative purposes is not meant to be limiting on the scope of the exemplary embodiments. Other such benefits and/or entitlements may be used with the TBA as described herein.

The customer has a transit subsidy benefit. This is a restrictive benefit since it can only be applied to qualifying purchases, typically from a qualifying merchant, based on the MCC, related to transit use. For example, the transit benefit may be applied to the purchase of a subway card. However, the grocery store would have an MCC than is not a qualified MCC for the transit subsidy so that benefit would not be applied to any part of the transaction. For this transaction, the transit subsidy would not be used. The rule hierarchy would proceed to the next rule.

In a similar manner to the above transit subsidy, the training benefit funds are also restrictive in their use and application. For example, the funds for the training benefit may be applied to qualifying training related transactions, such as the purchase of training materials or attending approved training courses as specific institutions. Here, the transaction at the grocery store would not qualify for application of the training benefit funds since it is not training related, as defined by the rules by the administering agency. In exemplary embodiments, this determination may be made based upon the MCC and/or the UPC of the items purchased.

The next most restrictive benefit this consumer has is the SNAP benefit, which may only be applied to purchase food items at authorized grocers. Therefore, the SNAP benefit may be applied to this transaction. The retailer POS software will have differentiated between SNAP-eligible and non-SNAP eligible items based on UPC data. In this example, only the milk and flour have qualifying codes for the SNAP benefit. Their total cost is $3. This cost may be applied against the consumer's SNAP allotment. However, the consumer has both regular SNAP and a disaster SNAP benefit. The disaster SNAP benefit may have an expiration date associated with the funds, so it would be applied before the regular SNAP benefit. Once the disaster SNAP funds are exhausted, then the regular SNAP funds would be applied. This is an example of a sub-rule applied at the same hierarchical level.

It should be appreciated that the hierarchy of the rule set for the restrictive benefits may be ordered in different ways. The rule hierarchy, as implemented by the financial institution, may be flexible in this regard. For example, the SNAP rules could be applied prior to the transit subsidy and the training benefit or the training benefit could be applied prior to the transit subsidy. In some embodiments, the order of application of the funds may make a difference. For example, the training benefit may allow transit transactions such that if the training benefit is applied prior to the transit subsidy for a transit related transaction, the training benefit funds may be applied towards the transaction. If the transit benefit is applied prior to the training benefit as above, then the transit benefit funds may be applied against a transaction for transit that the training benefit may have funded. Accordingly, the financial institution may have to determine a hierarchy for the different programs within the TBA and manage them accordingly to account for situations such as described. In some embodiments, the financial institution may monitor such transactions and flag them for the consumer's attention to determine the proper funds application.

There are now two remaining items to be funded—the cigarettes and the magazine. The customer has unemployment insurance and child support benefits. These benefits are typically not restricted in their use and therefore could be applied to these remaining items for purchase and an approval for the transaction would be transmitted. In accordance with exemplary embodiments, the funds for the unemployment insurance and child support benefits may be commingled in the TBA such that to the consumer, there is no difference in their use. The financial institution may maintain accounting of the benefits separately to provide any required reports to the sponsoring agencies.

In some embodiments, if the total available TBA balance was insufficient to fund the remaining cost of the cigarettes and magazine, a partial authorization may be sent for the remaining account balance based on the available funds. At this point, the consumer may have to make a choice on whether to proceed with the transaction. The consumer may pay cash out-of-pocket for the differential balance. It should be appreciated the preceding example is for illustrative purposes only and is not intended to limit the invention in any manner.

Lastly, at block 250, the transaction is completed. The financial institution sends an approval signal to the POS indicating the transaction is approved, partially approved, or cancelled based upon the application of the rules as described above. The consumer may then leave the store with the purchased items.

At block 260, data on the transaction is collected for reporting requirements. It should be appreciated the many benefit and entitlement programs have reporting requirements required by the agency or organization which administers the program. Accordingly, after the transaction is completed, or at any other point during the transaction processing, data relating to the transaction may be collected and stored as appropriate for reporting by the processing entity. Various data may be collected such as the item(s) purchased, amount spent, benefit or entitlement funds used, the account number of the card presented for the transaction, etc. The reporting requirements may vary in frequency and required data.

At block 270, refund/return processing is conducted. In some cases, a consumer may desire to return items purchased in the transaction. A refund may be desired for the return if a replacement is not desired or available. A hierarchy of rules may be applied to a refund in a similar manner to the hierarchy of rules being applied to the transaction. The refund rules may depend on the type of funds used for the transaction. For unrestricted funds, the refund may be added back to the appropriate account since the ownership of those funds belongs to the consumer upon distribution. In some embodiments, even if multiple unrestricted type benefits and/or entitlements are part of the TBA, a refund may be credited back against the total of the unrestricted funds rather than a specific funding pool within that group of funds. For the SNAP program, since ownership of such funds is not transferred to the consumer a refund may be credited back against the consumer SNAP allocation. However, the credit cannot exceed the consumer's original allocation. Any overage amount may be credit against the consumer unrestricted funds. A similar process may be followed for refunds for restricted or partially restricted funding programs. That is, any refund may not exceed the consumer's original allocation of funds or the total with any pending deposits for those restricted funds.

FIG. 3 depicts a flowchart of a rule hierarchy according to an exemplary embodiment. Exemplary method 300 is provided by way of example, as there are a variety of ways to carry out the methods disclosed herein. The method 300 as shown in FIG. 3 may be executed or otherwise performed by one or a combination of various systems, such as a computer implemented system. Each block shown in FIG. 3 represents one or more processes, methods, and/or subroutines carried out in the exemplary method 300. Each block may have an associated processing machine or computer, or the blocks depicted may be carried out through one processor machine. Input may be desired from a consumer or user during various parts of the below described method, the input may be accomplished through a user interface.

While the method of FIG. 3 illustrates certain steps performed in a particular order, it should be understood that the embodiments of the present invention may be practiced by adding one or more steps to the processes, and/or omitting steps within the processes.

The method of FIG. 3 can be seen to being with an incoming transaction 310. This incoming transaction may consist of a dollar amount for approval. As described above, the transaction may be made with a TBA card. The use of the TBA card by the consumer associates the transaction with the TBA, or single account, 320. A set of rules may be applied to determine the disposition of the funds in the account to be applied against the transaction. The set of rules, as depicted in FIG. 3, progresses through the consumer's available funds based upon the source of the funds, such as which program the funds originated from. The rules commence with the most restrictive use funds and move through the hierarchy towards the least restrictive use funds. As the rule hierarchy is moved through, funds may be applied from that set to the transaction portion which qualifies. The rule progression continues until the transaction amount is fully funded. Therefore, in some cases, not all the restriction levels depicted may be used.

The set of rules, restriction level A 330, are applied first. These rules are based on the most restrictive benefit held in the account. In this example, there is a training benefit which may only be used at certain providers. Next, the second set of rules, restriction level B 340 and 350, may be applied. In this example, there are two benefits for a similar use—a second training benefit for child care and child care funding under a separate child care subsidy program—however block 340 is assessed prior to block 350 since it may have a more restrictive caveat on it and therefore should be used prior to the funds in block 350. Next is restriction level C 360, which here is SNAP. Restriction level D 370 and restriction level E 380 are applied in turn. In this example, the consumer has TANF and unrestricted agency owned benefits, for example, these agency owned funds may be disaster assistance funds. They may almost unrestricted in their use, but they often have an expiration date. Finally, unrestricted consumer-owned funds 390 may be applied to the transaction. There is no restriction level associated with these type funds since they belong to the consumer, subject to any applicable escheatment laws. For example, these could be payroll wages and/or Social Security entitlements earned by the consumer. It should be appreciated that these unrestricted funds may have the same usages rules and there may be put together into one funding “pot” or purse such that the unrestricted funds are considered as an aggregate instead of by individual source. As described above, the unrestricted funds having an expiration date may be separately considered and drawn upon for qualifying transactions to ensure that such funds are expended prior to their expiration date. A first in, first out type hierarchy may be used. At block 395, the transaction may be approved, if sufficient funds were available to cover the transaction. Alternatively, the transaction may be partially approved as described above.

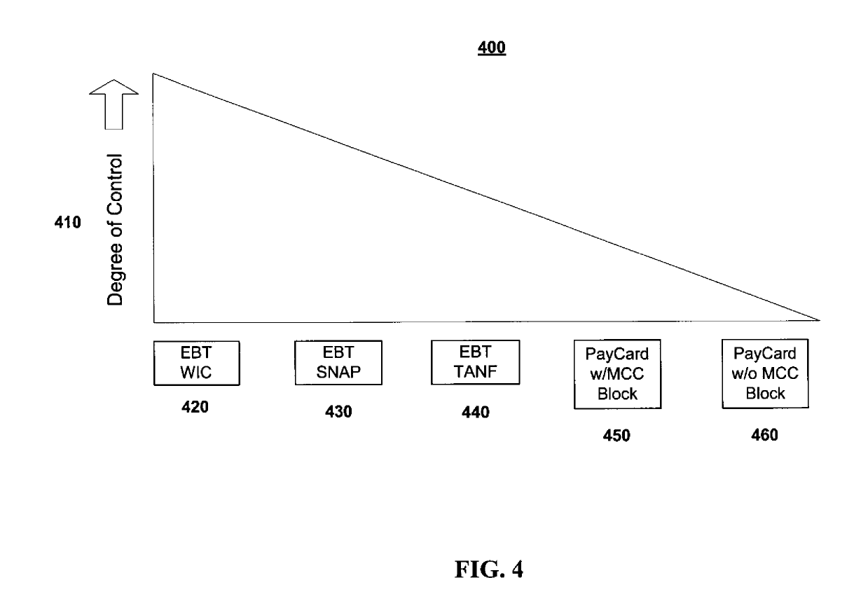

FIG. 4 depicts a flowchart of a funding degree of control hierarchy according to an exemplary embodiment. Exemplary FIG. 4 is provided by way of example, as there are a variety of ways to depict the funding control levels. While FIG. 4 illustrates certain programs, benefits, and entitlements in a particular order, it should be understood that the embodiments of the present invention may be practiced by adding one or more programs, benefits, and/or entitlements to those shown and altering the order of the programs shown based on rule hierarchy.

Degree of control 410 is shown on the vertical axis of FIG. 4. The degree of control 410 increases in a vertical direction, with the highest amount of control being on the left side of FIG. 4. The horizontal axis of FIG. 4 has a series of programs ordered across it. The degree of control for the programs decreases from left to right. The EBT WIC program 420, shown at the left side of FIG. 4, has the most restrictive rules associated therewith, as compared to the other programs depicted in FIG. 4. The remaining programs are shown in decreasing control order: EBT SNAP 430, EBT TANF 440, PayCard with MCC Block 450, and PayCard without MCC Block 460. It should be appreciated that other benefits and/or entitlement programs could be shown on FIG. 4. The PayCards shown in 450 and 460 are of the type of card that may be issued with a training benefit and a payroll entitlement, respectively. It should be appreciated that these cards may be associated with direct deposit benefits into a DDA or a TBA, as described above.

Below is provided an exemplary listing of benefit and entitlement programs, organized by hierarchy level from most restrictive to least restrictive.

Womens, Infants, Children (WIC)

Low-Income Heating Assistance

Transit subsidies

Training Benefit

Trade Adjustment Act

Child care subsidies

Supplemental Nutrition Assistance Program (SNAP, commonly called Food Stamps)

Health Savings Account (HSA)

Disaster Assistance

Foster care subsidies

Elder care subsidies

Temporary Assistance to Needy Families (TANF)

Refugee assistance

Assistance to the blind

Individual Development Accounts

Social Security

Supplemental Security Income (SSI)

Workers compensation

Unemployment insurance

Veterans benefits

Youth employment

Inmate release stipends

Other payments (jury duty, etc.)

The above list is exemplary only and is not meant to be all inclusive. Further, it should be appreciated that the hierarchy order may change based on benefit and/or entitlement rules or program changes as imposed by the agency or entity that administers said programs or changes may occur through other factors. Further, as described above, the hierarchy order may be flexible such that the financial institution may adjust the rule hierarchy for different situations. It should also be appreciated that the following benefits are typically unrestricted in their usage and therefore would be commingled in the TBA: Social Security, SSI, workers compensation, unemployment insurance, Veterans Benefits, child support, youth employment, inmate release stipends, other payments (jury duty, etc.). These funds may therefore be applied towards any purchase made by the consumer that may not be covered by any of the more restrictive program funds.

The above examples of the use of the targeted benefit account and its associated transaction card are meant to be exemplary in nature and are not meant to be limiting on the scope of the exemplary embodiments of the present invention. Accordingly, the use of particular benefit and entitlement programs in the examples as described are exemplary only and are not meant to limit the scope because certain benefit and/or entitlement programs are used as illustrative examples. Any such benefit and/or entitlement program may be used with the TBA according to exemplary embodiments.

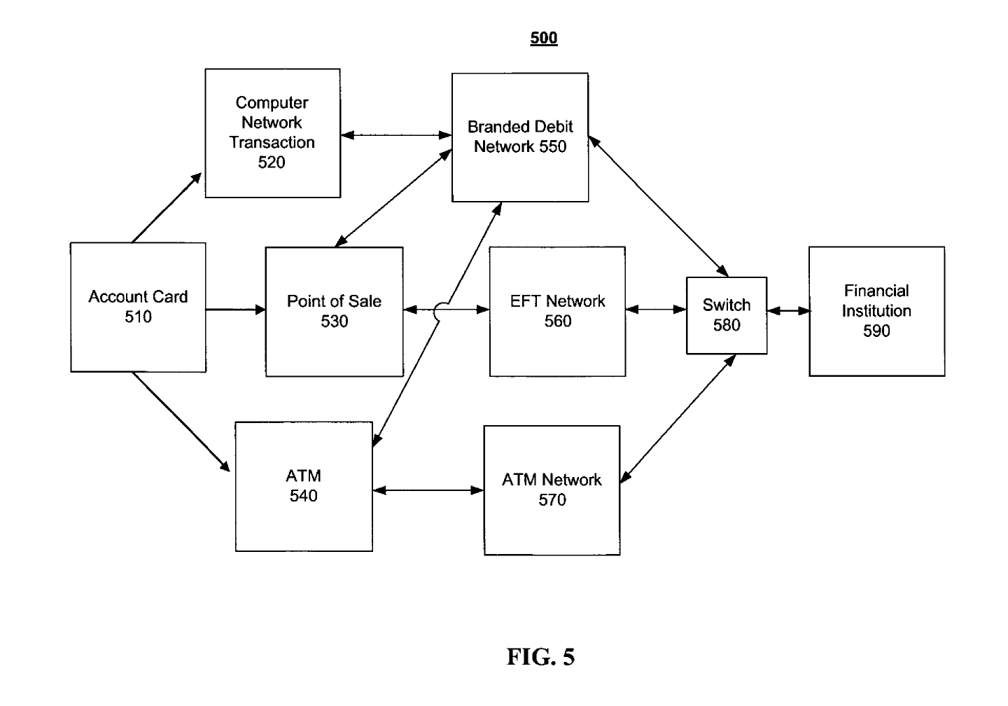

FIG. 5 is a transaction processing system according to exemplary embodiments of the present invention. System 500 may provide various functionality and features associated with transaction processing, such as for transaction processing for a TBA card. More specifically, system 500 may include, among other things, an account card 510, a computer network transaction 520, a point of sale transaction 530, an ATM transaction 540, a branded debit network 550, an EFT network 560, an ATM network 570, a switch 580, and a financial institution 590. The components shown may be further duplicated, combined and/or separated across multiple systems at local and/or remote locations. Other implementations and architectures may be realized. It should be appreciated that system 500 may include computers, such as general purpose computers which may include a processing machine which has one or more processors. Such a processing machine may execute instruction stored in a memory or memory to process the data. Further, as shown in the system 500, computer networks and other computer based components may be included.

System 500 as depicted in FIG. 5 shows three different exemplary transaction types and their processing, by way of non-limiting example. The three transaction types are: a computer network transaction 520, a point of sale transaction 530 (which includes both signature based transactions and a PIN based transactions), and an ATM transaction 540. It should be appreciated that the computer network transaction 520 may include computer based transactions, for example, internet transactions and electronic bill payment. These transactions may be conducted over a computer based network, such as, but not limited to, the internet. A transaction conducted as a point of sale transaction 530 may include both the use of a card and cash in any combination. The transaction may be initiated with an account card 510. The consumer uses the account card 510 for a transaction at a merchant or on an e-commerce or other internet site or enters the card number into an electronic bill payment system, for example. The account card 510 may be associated with a TBA. The account card 510 may be recognized as a debit card and the transaction processed appropriately. Alternatively, as described above, the consumer may select a button at the point of sale or perform a selection on a website or other type of computer user interface, such as a graphical user interface, indicating the type of transaction, for example, “credit/debit.”

As can be seen in system 500, each transaction type is routed through the appropriate network, either a branded debit Network 550, an EFT network 560, or an ATM network 570. For example, the branded debit network 550 may be associated with VISA or MasterCard. This branded debit network may accept either PIN based or signature based transactions, or a combination thereof. The EFT network 560 and the ATM network 570 may be associated with any of pulse, STAR, NYCE, PLUS, or CIRRUS. The ATM network 570 may also have branded debit networks associated therewith as shown. These networks may accept PIN based transactions. Following routing through the appropriate network, a switch 580 routes the transactions to a financial institution 590. The financial institution 590 receives requests for authorization of the transaction and then passes back an appropriate approval notification back through the networks, as shown by the two-way arrows in system 500. In accordance with exemplary embodiments, the financial institution 590 may maintain the TBA associated with the account card 510. Accordingly, upon receipt of the transaction request through the appropriate network, the financial institution 590 may apply a rule hierarchy to the transaction as described above to determine the appropriate TBA funding application towards the transaction. Upon completion of the rule application, the approval or denial of the transaction may be routed back through the appropriate network. The financial institution 590 may also issue reports conduct with the transaction processing. The reports may be required by entities, and forwarded by the financial institution thereto, that sponsors the benefits and/or entitlements used in conjunction with the account card 510 in the system 500. It should further be appreciated that other types of transactions and networks may be used with the system 500.

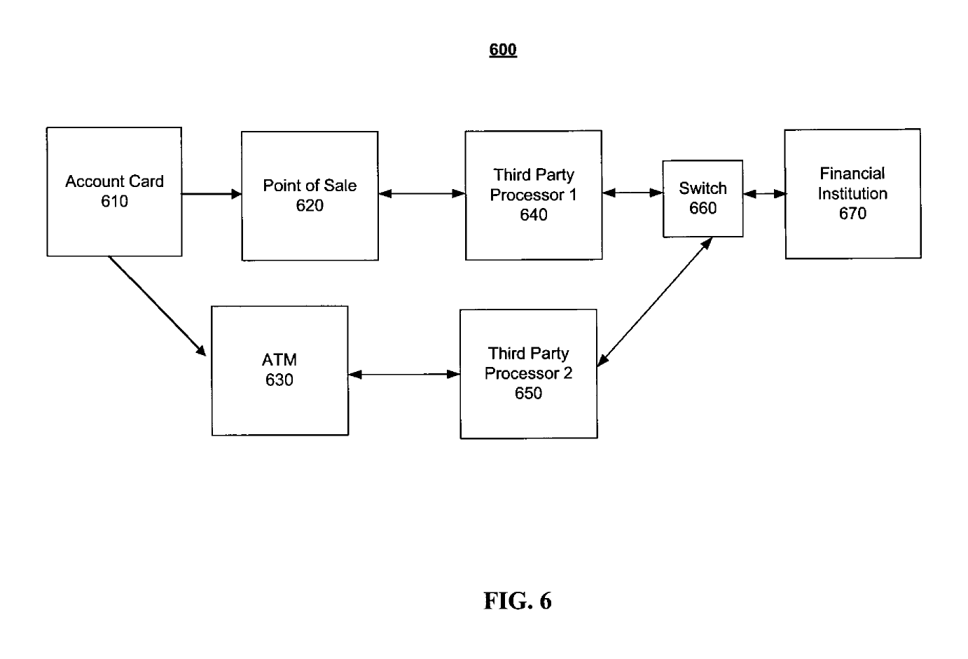

FIG. 6 is a transaction processing system for EBT transactions according to exemplary embodiments of the present invention. System 600 may provide various functionality and features associated with transaction processing, such as for transaction processing for a TBA card. More specifically, system 600 may include, among other things, an account card 610, a point of sale transaction 620, an ATM transaction 630, a first third party processor 640, a second third party processor 650, a switch 660, and a financial institution 670. The components shown may be further duplicated, combined and/or separated across multiple systems at local and/or remote locations. Other implementations and architectures may be realized. It should be appreciated that system 600 may include computers, such as general purpose computers which may include a processing machine which has one or more processors. Such a processing machine may execute instruction stored in a memory or memory to process the data. Further, as shown in the system 500, computer networks and other computer based components may be included.

System 600 as depicted in FIG. 6 shows two different transaction types and their processing. The two transaction types are: point of sale transaction 620 and ATM transaction 630. These two transaction types are provided by way of non-limiting example. The transaction may be initiated with an account card 610. The consumer uses the account card 610 for a transaction at a merchant. The account card 610 may be associated with a TBA. The consumer may select “EBT” at the point of sale 620 during the transaction. At the ATM 630, the account card 610 may be recognized as an EBT card by the ATM. It should be appreciated that the point of sale 620 may include transactions conducted over a computer based network by the cardholder, for example, e-commerce transactions conducted over the Internet. The transactions may be conducted through a computer based interface, for example, an internets website, through an merchant associated with the website.

As can be seen in system 600, each transaction type is routed through the appropriate network, either a first third party processor 640 or a second third party processor 650. For example, the first third party processor 640 may be associated with BuyPass or PathMark and the second third party processor 650 may be associated with Visa, MasterCard, or Quest. Following routing through the appropriate network, a switch 660 routes the transactions to a financial institution 670. The financial institution 670 receives requests for authorization of the transaction and then passes back an appropriate approval notification back through the networks, as shown by the two-way arrows in system 600. In accordance with exemplary embodiments, the financial institution 670 may maintain the TBA associated with the account card 610. Accordingly, upon receipt of the transaction request through the appropriate network, the financial institution 670 may apply a rule hierarchy to the transaction as described above to determine the appropriate TBA funding application towards the transaction. Upon completion of the rule application, the approval or denial of the transaction may be routed back through the appropriate network. In some embodiments, the financial institution 670 may be acting as the transaction network. For example, the financial institution 670 may serve as the Quest network, since the Quest network, which may be associated with SNAP, is a pseudo-network. The financial institution 670 may also issue reports conduct with the transaction processing. The reports may be required by entities, and forwarded by the financial institution thereto, that sponsors the benefits and/or entitlements used in conjunction with the account card 610 in the system 600.

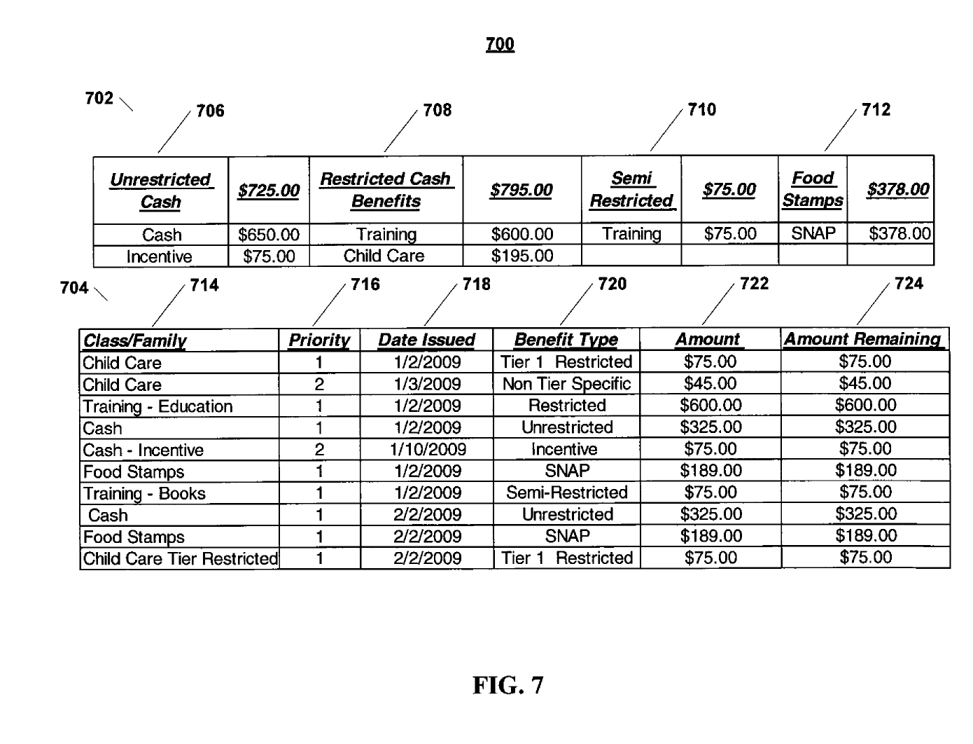

FIG. 7 is an account balance example for a TBA. This account balance is provided by way of non-limiting example. The account 700 has two balance charts: chart 702 and chart 704. The chart 702 shows an account balance grouped by funding restriction level and the chart 704 shows a more detailed listing of the account funding. For illustrative purposes, this TBA account belongs to Mary Smith and Mary has been issued a TBA card for this TBA. The following charts provide illustrative examples of the use of a TBA and are meant to be exemplary in nature.

The chart 702 has four sections labeled as 706, 708, 710, and 712. The section 706 represents the unrestricted cash balance. The section 708 represents the restricted cash benefits balance. The section 710 represents the semi-restricted or partially restricted balance. Finally, the section 712 represents the Food Stamps or SNAP balance. The chart 704 provides the details of each of the items that make up each balance: the class/family or name of the funding source 714, the priority 716, the date issued 718, the benefit type 720, the amount 722, and the amount remaining 724.

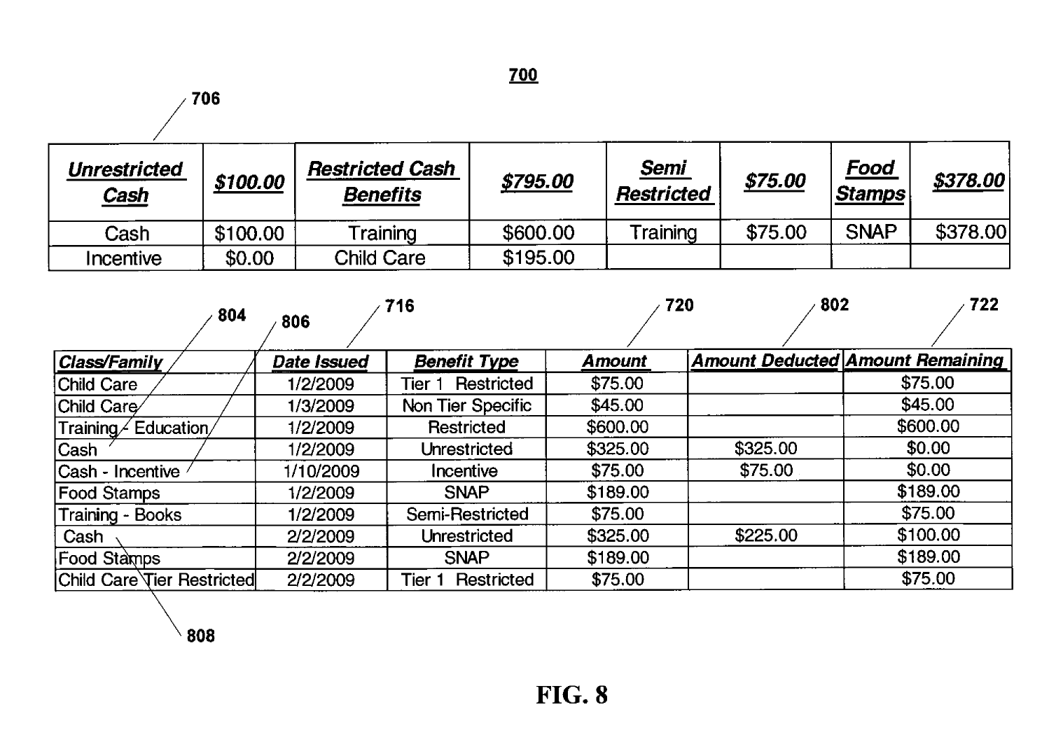

FIG. 8 depicts the account 700 showing the deduction of a transaction. Mary went to an ATM and requested $625. Only eligible funds may be withdrawn as cash from an ATM. In this example, the only eligible funds that Mary are in the unrestricted cash section 706. Mary has a total of $725 available in unrestricted cash prior to the transaction. After the transaction, Mary has $100 available. Section 802 show the deduction for the cash withdrawal. The rule hierarchy in applied in a first in, first out manner to the withdrawal. Accordingly, the cash 804 issued on Jan. 2, 2009 in the amount of $325 was applied to the transaction first. Since there a balance for the transaction remained to be satisfied after the application of this funding, the cash incentive 806 issued on Jan. 11, 2009 in the amount of $75 was applied next. A balance of $225 remained to satisfy the transaction, so therefore the cash 808 issued on Feb. 2, 2009 was applied next. This example illustrates a vertical application of the rules (moving within a category).

If Mary had requested $800 from the ATM, her transaction may have been denied since her unrestricted cash balance 706 was only $725. Alternatively, the transaction may have been authorized for the $725, with a warning that the remaining $75 was not available. In some embodiments, Mary may be presented with an option as to whether she wishes to proceed with a partial withdrawal as just described.

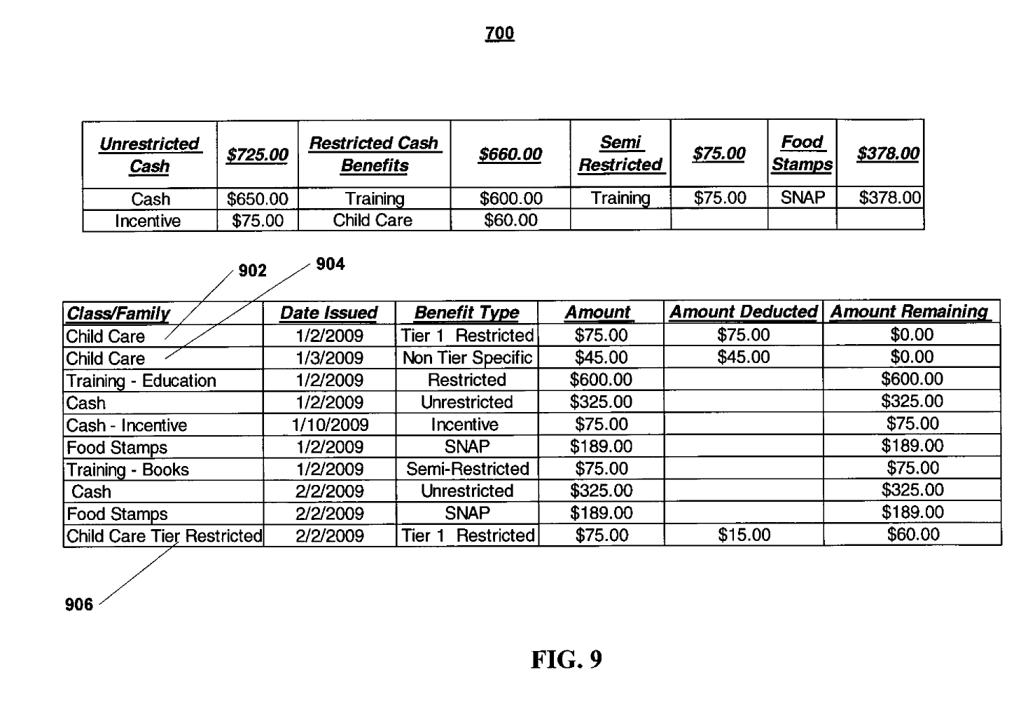

FIG. 9 depicts the account 700 showing another transaction, independent of the transaction described in FIG. 8. Here, Mary has made a $135 payment to a day care center, that is a registered tier 1 provider. Accordingly, the child care tier 1 benefit 902 issued on Jan. 2, 2009 is reduced by $75 (its full amount). Next, the child care benefit 904 issued on Jan. 3, 2009 is debited for $45 (its full amount). Finally, to complete the transaction, the child care tier 1 benefit 906 issued on Feb. 2, 2009 is debited for $15, the remaining balance of the $135. In this example, a first in, first out rule hierarchy was applied.

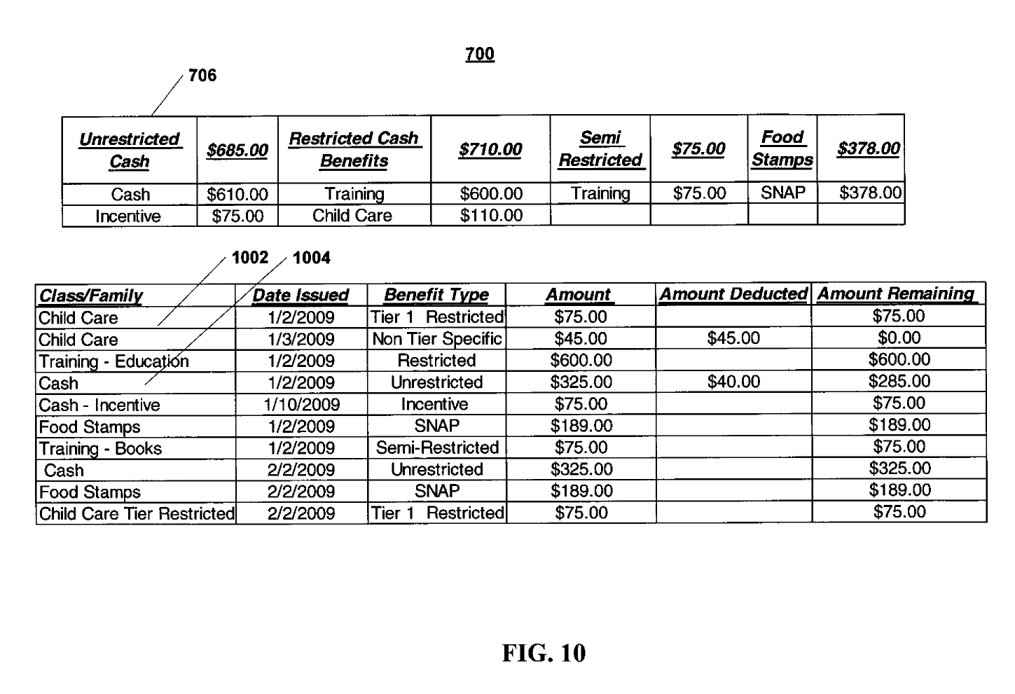

FIG. 10 depicts the account 700 showing another transaction, independent of the transactions described above. Here, Mary has made a $85 payment to a day care center, that is a registered tier 3 provider. Accordingly, the child care benefit 1002 issued on Jan. 3, 2009 is reduced by $45 (its full amount). Since no further child care benefits are available to apply to the cost (the only other child care benefits are tier 1), the unrestricted cash 1004 issued on Jan. 2, 2009 is debited for $40, the remaining balance of the $85. This example depicts both a vertical and a horizontal application (moving to another category) of the rule hierarchy as described above. The unrestricted cash 1004 is debited since it was issued first. The unrestricted cash 706 now has a balance of $650.

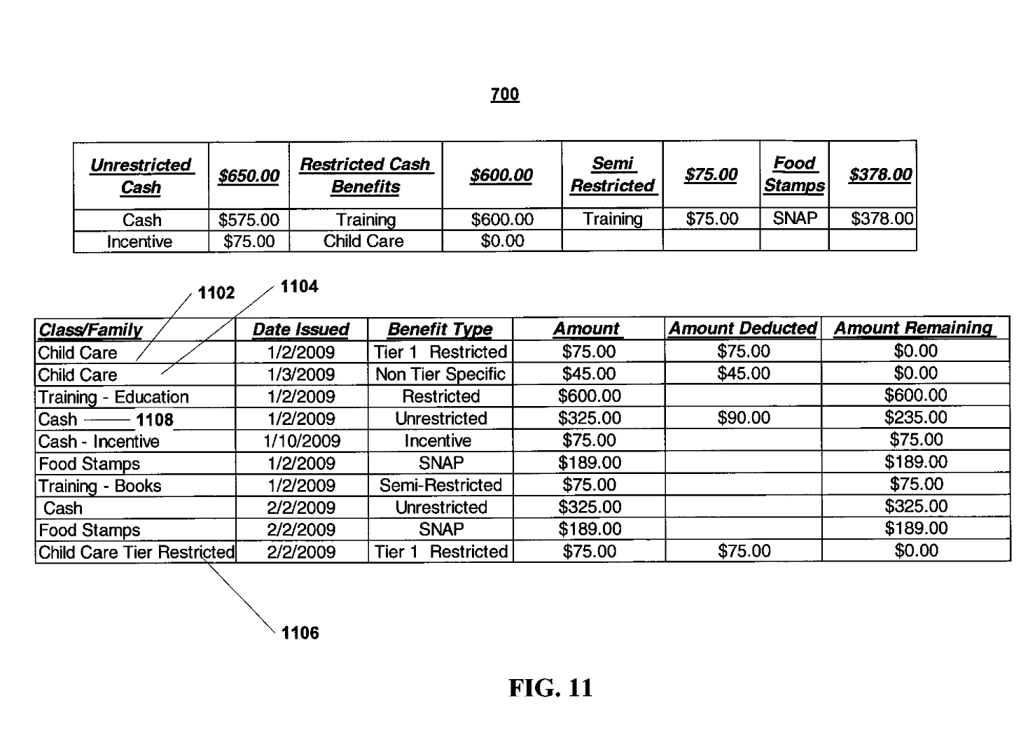

FIG. 11 depicts the account 700 showing another transaction, independent of the transactions described above. Here, Mary has paid $285 at a day care center, that is a registered tier 1 provider. Accordingly, the child care tier 1 benefit 1102 issued on Jan. 2, 2009 is reduced by $75 (its full amount). Next, the child care tier 1 benefit 1106 issued on Feb. 2, 2009 is debited for $75. Next, the child care benefit 1104 issued on Jan. 3, 2009 is debited for $45 (its full amount). However, a balance of $90 remains, so the cash 1108 issued on Jan. 2, 2009 is debited for $90 to complete the transaction. The tier 1 child care benefit 1102 is debited prior to the non-tier specific child care benefit 1104. In embodiments of the rule hierarchy, benefits may be exhausted based upon a priority ranking order instead of relying solely upon the deposit date. Referring back to FIG. 7, the priority 716 shows that the tier 1 child care 1102 has a priority of 1 and the non-tier specific child care 1104 has a priority of 2.

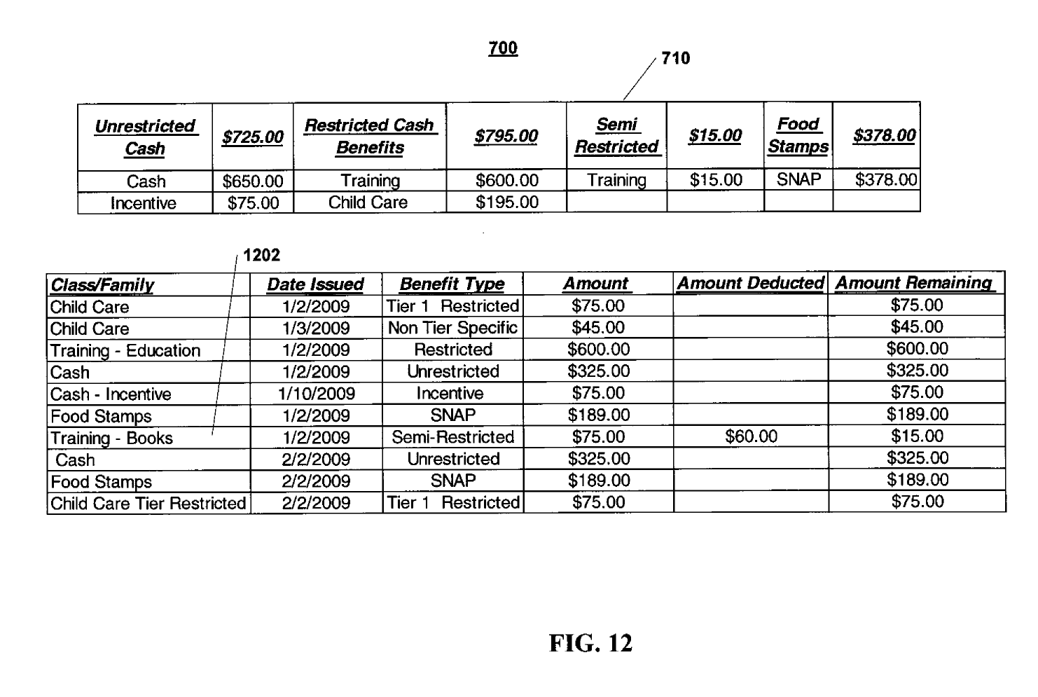

FIG. 12 depicts the account 700 showing another transaction, independent of the transactions described above. Here, Mary has made a $60 purchase at a university book store, which has an MCC registered code. Accordingly, the training funds 1202 issued on Jan. 2, 2009 are reduced by $60. Since this covers the purchase, no further debiting of funds is required The semi-restricted funds 710 now has a balance of $15.

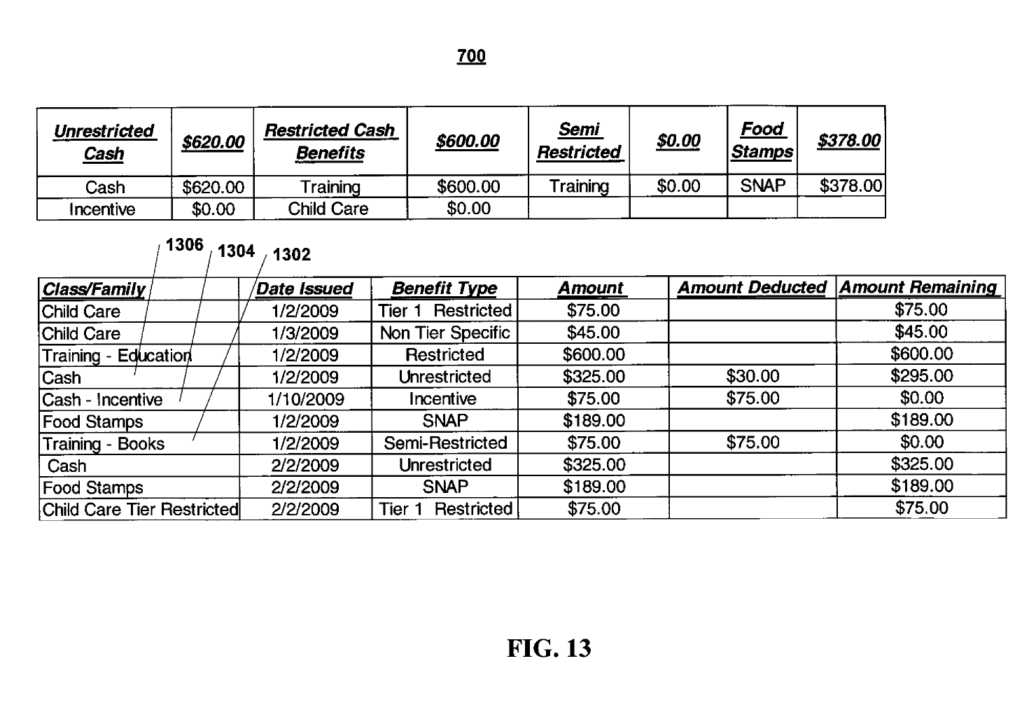

FIG. 13 depicts the account 700 showing another transaction, independent of the transactions described above. Here, Mary has made a $180 purchase at a university book store, which has an MCC registered code. Accordingly, the training funds 1302 issued on Jan. 2, 2009 are reduced by $75 (its full amount). However, a balance still remains. Next, the cash incentive 1304 issued on Jan. 10, 2009 may be debited $75 (its full amount). Finally, to cover the remaining balance, the cash 1306 issued on Jan. 2, 2009 is debited $30. Since this covers the purchase, no further debiting of funds is required. This example is another depicted of vertical and horizontal rule application using a priority ranking within a group. Here, the cash incentive 1304 was applied to the transaction before the cash 1306 since for this transaction, the cash incentive had a higher priority since it was from the same program as the training funding 1302.

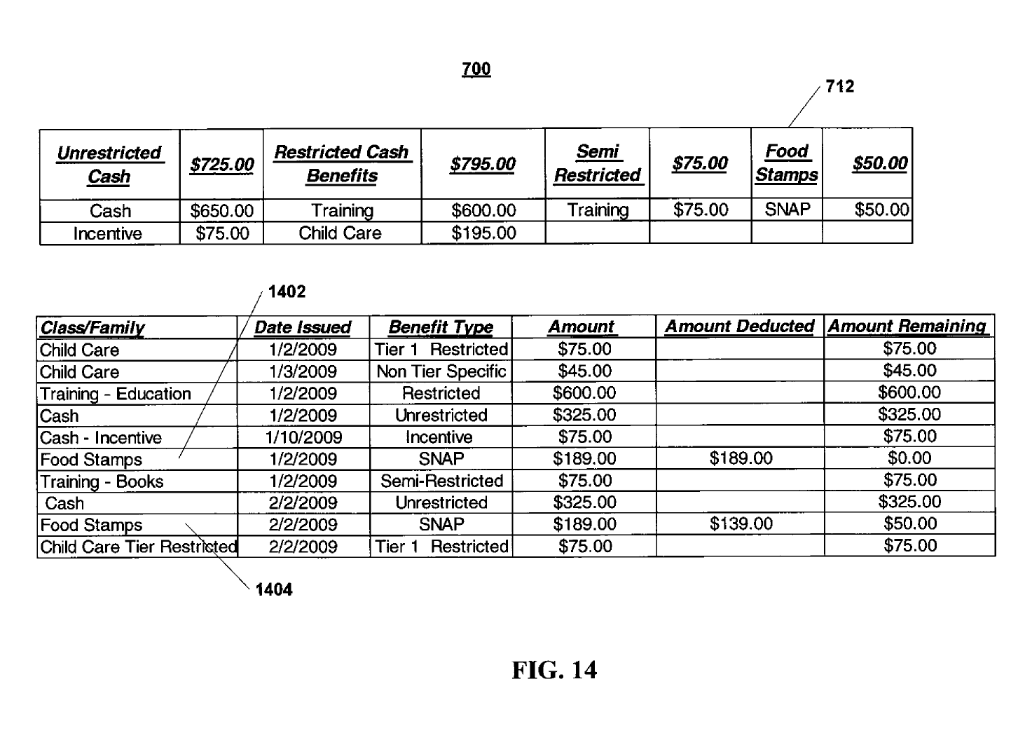

FIG. 14 depicts the account 700 showing another transaction, independent of the transactions described above. Here, Mary has made a $328 purchase at a grocer. Her purchase meets the requirements of the SNAP program. The transaction is at a registered merchant and the transaction type from the POS is identified as SNAP. Accordingly, the SNAP funds 1402 and 1404 in Mary's account are reduced to cover the amount. First, SNAP funds 1402 are debited followed by SNAP funds 1404 to cover the remaining balance. As shown, Mary's food stamps balance 712 is now $50.

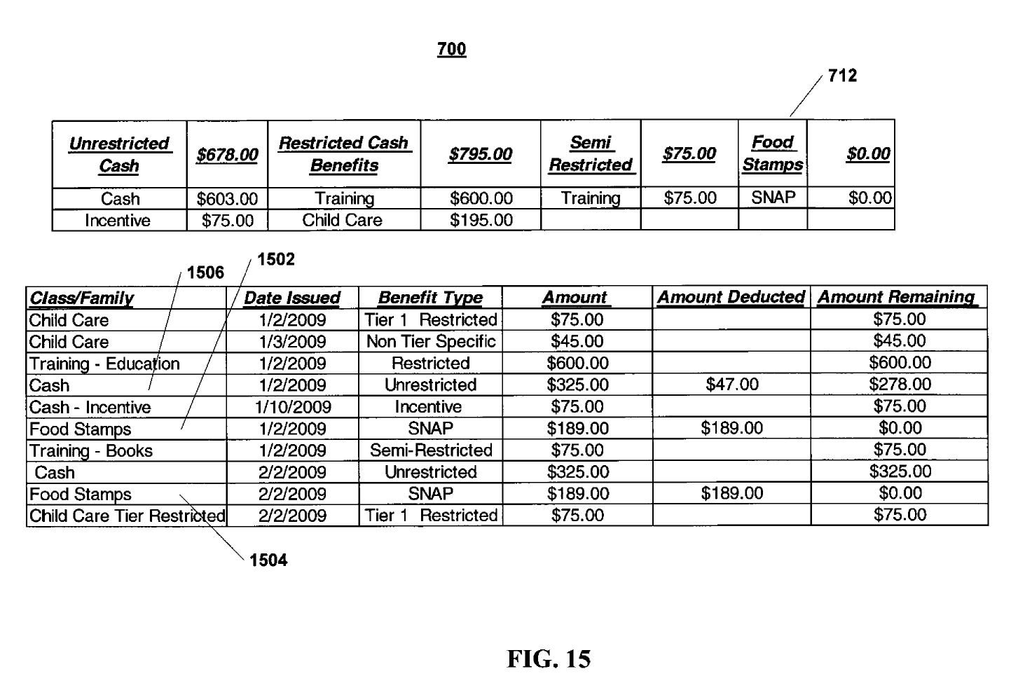

FIG. 15 depicts the account 700 showing another transaction, independent of the transactions described above. Here, Mary has made a $425 purchase at a grocer. Her purchase meets the requirements of the SNAP program. The transaction is at a registered merchant and the transaction type from the POS is identified as SNAP. Accordingly, the SNAP funds 1502 and 1504 in Mary's account are reduced to cover the amount. However, there is still a remaining balance. Accordingly, the rules hierarchy may move horizontally to the unrestricted cash and debit the cash 1506 for the remaining balance.

Hereinafter, aspects of implementation of the invention will be described. In an exemplary embodiment of a system of the invention, the embodiment may be computer implemented. The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example. As described herein, a module performing functionality may comprise a processor and vice-versa.

As noted above, the processing machine used to implement the invention may be a general purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the process of the invention. The processing machine may be communicatively coupled to one or more other processing machines either directly or through a computer based network. The computer based network may be a Local Area Network or the internet. Other types of computer networks may be used. Combinations of computer based networks may be used for communication between the processing machines.

It is appreciated that in order to practice the method of the invention as described above, it is not necessary that the processors and/or the memories of the processing machine be physically located in the same geographical place. That is, each of the processors and the memories used in the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Ruby, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As described above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

Data associated with the computer system and processing machines may be stored in any suitable storage device. The storage device may include multiple data storage devices. The multiple data storage devices may be operatively associated with the processing machine and computer system. The storage may be local, remote, or a combination thereof. A redundant array of disks (RAID), striped disks, hot spare disks, tape, disk, or other computer accessible storage may be used. In one or more embodiments, the storage may be a storage area network (SAN), an internet small computer systems interface (iSCSI) SAN, a Fibre Channel SAN, a common Internet File System (CIFS), network attached storage (NAS), or a network file system (NFS). The storage may have back-up capability built-in. Communications with the storage may be over a network, or communications may be over a direct connection. Data may be transmitted and/or received from the storage device. Data transmission and receipt may utilize cabled network or telecom connections such as an Ethernet RJ45/Category 5 Ethernet connection, a fiber connection, a traditional phone wireline connection, a cable connection or other wired network connection. A wireless network may be used for the transmission and receipt of data.

One or more databases may be used for storage and organize of TBA data, such as an Oracle database, a Microsoft SQL Server database, a DB2 database, a MySQL database, a Sybase database, an object oriented database, a hierarchical database, a flat database, and/or another type of database as may be known in the art that may be used to store and organize data associated with the TBA as described herein.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

While the embodiments have been particularly shown and described within the framework of execution of trades, it will be appreciated that variations and modifications may be effected by a person of ordinary skill in the art without departing from the scope of the invention. Furthermore, one of ordinary skill in the art will recognize that such processes and systems do not need to be restricted to the specific embodiments described herein. Other embodiments, uses and advantages of the present invention will be apparent to those skilled in the art from consideration of the specification and practice of the invention disclosed herein. The specification and examples should be considered exemplary. The intended scope of the invention is limited by the claims appended hereto.

1. A computer-implemented method for establishing a targeted benefit account, comprising:
receiving, electronically over a computer based network, enrollment data, from a plurality of entities, for a plurality of programs for at least one consumer,
wherein each of the plurality of programs has associated funds and the use of the funds is governed by a set of predetermined rules defining restrictions on fund usage for transactions wherein the restrictions comprise at least one of a usage category or a merchant type;
establishing, by at least one computer processor, an account for the at least one consumer, wherein the at least one consumer is enrolled in each of the plurality of programs based on the enrollment data;
issuing at least one transaction card to the at least one consumer, wherein the at least one transaction card is associated with the account and is personalized for the at least one consumer,
wherein the at least one transaction card is usable for transactions;
notifying each of the plurality of entities of the account establishment;
receiving the funds associated with each of the plurality of programs, over the computer based network, for deposit into the account, following establishment of the account;
establishing, by at least one computer processor, a hierarchy based on the sets of predetermined rules for each of the plurality of programs such that the hierarchy establishes how the funds from each of the plurality of programs are applied to a transaction conducted with the transaction card;
activating, by the at least one computer processor, the at least one transaction card;
receiving, electronically, transaction data from with a transaction conducted with the at least one transaction card, the transaction data comprising a transaction amount and at least one of a transaction type or a merchant identifier;
applying the hierarchy to the transaction data iteratively until the transaction amount is fulfilled such that the funds in the account are applied, through the hierarchy, based on a combination of the restrictions on fund usage and at least one of the transaction type or the merchant identifier, such that funds having a more restrictive usage are applied prior to funds having a less restrictive usage;
transmitting, electronically over a computer based network, an authorization for the transaction following the application of the hierarchy; and
automatically applying, by the at least one computer processor, a plurality of predetermined refund rules upon a refunding of the transaction, wherein the plurality of predetermined refund rules are applied to credit the refunded funds to the account based upon a hierarchy in a manner corresponding to the hierarchy applied to the funds to authorize the transaction.

2. The method of claim 1, further comprising:
deactivating the account.

3. The method of claim 1, further comprising:
administering the account by a financial institution, wherein administering comprises completing reporting requirements established by the plurality of entities.

4. The method of claim 1, wherein at least one of the plurality of entities is a private entity.

5. The method of claim 1, wherein at least one of the plurality of entities is a government agency.

6. The method of claim 1, wherein each of the plurality of programs comprises benefit or entitlement programs.

7. (canceled)

8. (canceled)

9. The method of claim 1, wherein the funds associated with the plurality of programs are separated into sub-accounts within the account based on the usage categories.

10. The method of claim 1, wherein at least one of the plurality of programs has associated funds having an expiration date and the funds with the expiration date are applied by the hierarchy before funds not having an expiration date.

11. The method of claim 1, further comprising:
receiving funds from the at least one consumer for deposit into the account,
wherein the funds from the at least one consumer have an unrestricted usage category associated therewith and the funds are accessible through the transaction card for use in a transaction.

12.-23. (canceled)

24. The method of claim 1, wherein the transaction card comprises two transaction cards such that a first transaction card is for programs having more restrictive funds and the second transaction card is for programs having less restrictive funds.

25. The method of claim 1, wherein the authorization comprises an approval based on the funds being available to fulfill the transaction amount, a partial approval based on funds in the account being available to fulfill less than an entirety of the transaction amount, or a cancellation.
